(19) United States
(12) Patent Application Publication
(10) Pub. No.: US 2012/0239655 A1
(43) Pub. Date: Sep. 20, 2012

(54) DISTRIBUTED STORAGE AND METADATA SYSTEM

(76) Inventors: Ronald Steven Cok, Rochester, NY (US); Joseph Anthony Manico, Rochester, NY (US)

(21) Appl. No.: 13/047,982

(22) Filed: Mar. 15, 2011

(51) Int. Cl. G06F 17/30

(52) U.S. Cl. 707/739; 707/E17.02

(57) ABSTRACT

A system for storing digital images and accessing and storing digital image information using a communication network includes a plurality of independently controlled digital storage repositories associated with one or more different authorization groups, wherein a first digital storage repository includes a first digital image with associated first semantic information and wherein a second digital storage repository in a common authorization group with the first digital storage repository includes a second digital image with associated second semantic information and an associated second category, and wherein the processor of the first digital storage repository uses its computer program to independently access and match the first semantic information with the second semantic information, to associate the second category with the first semantic information, and to store the second category in association with the first semantic information in the first digital storage repository.

### CROSS REFERENCE TO RELATED APPLICATIONS

Reference is made to commonly assigned U.S. patent application Ser. No. 13/042,501, filed Mar. 8, 2011, entitled DISTRIBUTED IMAGE ACQUISITION AND STORAGE SYSTEM, by Ronald S. Cok, et al and U.S. patent application Ser. No. 13/042,503, filed Mar. 8, 2011, entitled Distributed Image Acquisition, Communication, and Storage System, the disclosure of which is incorporated herein.

### FIELD OF THE INVENTION

The present invention relates to digital image acquisition and storage system and, in particular, to a distributed storage system with metadata.

### BACKGROUND

Since the inception of consumer photography over 120 years ago, numerous innovations have been developed to ease the costs and complexities of taking, viewing, and sharing photographs. The original invention of flexible roll film provided the ability to record multiple, sequential photographs without glass plates, chemicals, and reloading cameras. This innovation combined with the simple, inexpensive, and easy to use “box camera” (U.S. Pat. No. 388,850) and centralized photo processing made picture taking more affordable and accessible. Innovations such as easy-to-load film cartridges, motorized film advance, automatic exposure, electronic flash, automatic focus, one-time use cameras, compact cameras, and zoom lenses were directed at reducing the burden of photography. In addition, the development of integrated photo-processing equipment or “mini-labs” and “photo kiosks” made photo-processing and printing in retail environments feasible.

More recently, the development of digital cameras has provided significant benefits. Digital cameras are a common and widely used consumer electronics product used by many people to record images and events in their lives. However, such cameras have also placed new burdens on consumer photographers. The conventional process for acquiring and managing digital images is cumbersome. Digital cameras with complex control mechanisms and modes are used to acquire images. Digital images are typically captured with an electronic sensor integrated circuit in response to a user-operated control and stored in an electronic memory in the digital camera, such as a flash memory unit. After some period of time, the camera is plugged into a computer through a wired interface such as a Universal Serial Bus (USB) connector and the digital images are downloaded through an interface to a computer. Wireless transfer systems employing WiFi protocols and hardware over local area networks are also known.

The computer executes an image-transfer program to transfer digital images from the electronic memory of the camera to a storage device controlled by the computer, for example rotating magnetic media such as a disk. A complex software program can then be used to manipulate, store, print, or otherwise employ the digital images. The images are viewed, manipulated, printed, and permanently stored on a personal computer or stored in a server of an on-line service over the Internet.

Although digital cameras eliminate the costs and complexity of film usage and processing, the user of digital photography systems can encounter a wide variety of problems. Various incompatible file formats, numerous incompatible memory card formats, image file transfer, image file storage and access, on-line image file storage, incompatible computer devices with incompatible software and interfaces, computer-centric software, and post-capture operations have added to the complexity and costs of photography. Organization, storage, and redundant backup of personal photo collections, sometimes including many thousands of digital images and video clips, become the responsibility of the photographer. Simple photo albums, shoeboxes, and slide trays that were once the final repository of irreplaceable images were directly viewable and readily understood and used. Photographic prints, slides, and negatives are today replaced by digital-media collections. These digital-media collections are often scattered across the hard drives of several different computers, on various types of digital storage devices such as removable hard drives, optical disks, Photo CDs, CDs, DVDs, and memory cards.

On-line storage accounts provide a new method to aggregate digital media collections and assure redundant back up, but these systems require the user to periodically upload their newly acquired digital images to the on-line storage account and are subject to the rules, limitations, and fees established by the on-line storage provider. Many digital cameras require the interactive use of a computer to transfer images from the camera to a secondary storage device or system. In addition, file formats and storage devices become obsolete as new digital cameras and computers become available. These problems interfere with the simple pleasure of taking and using photographs. In particular, digital photography practitioners can accommodate a variety of computers and computing devices, complex, non-standard user interfaces, complex workflows, image-storage management, security challenges, and incompatible image storage formats.

The use of computer networks with a variety of connected electronic devices, including storage devices is known, for example as disclosed in U.S. Pat. No. 6,928,476 and U.S. Patent Publication 20050060700. U.S. Pat. No. 6,678,737 describes data management units on computer networks with associated display devices. Content management systems and networks are described in U.S. Patent Publications 20060026171, 20050177869, 20050125484 and 20040162900. Systems for storing, sharing, and displaying digital images in a common collection, including images obtained from digital cameras are known, for example as taught in U.S. Pat. Nos. 7,024,051, 7,724,285, and 7,675,554. U.S. Pat. Nos. 7,742,084 and 7,701,490 describe transferring images from a digital camera to desired locations through a wireless network.

U.S. Pat. No. 6,236,971 entitled “System for controlling the distribution and use of digital works using digital tickets” teaches a system for controlling the distribution and use of digital works using digital tickets used to entitle the ticket holder to exercise some usage right with respect to a digital work.

Usage rights are used to define how a digital work is used or distributed. Each usage right can specify a digital ticket which is present before the right can be exercised. Digital works are stored in repositories which enforce a digital works usage rights. Each repository has a “generic ticket agent” which punches tickets. In some instances only the generic ticket agent is necessary. In other instances, punching by a “special ticket agent” residing on another repository is needed. Although this system provides rights control, it does not provide information sharing within secure groups.

It is also known to compare image collections belonging to different users. For example, U.S. Pat. No. 7,668,405 entitled “Forming connections between image collections” describes a method of establishing a connection between two image collections. The method includes providing a first image collection from a first user; providing a second image collection from a different second user; analyzing the first and second image collections to produce a similarity score between the first and second image collections; and establishing a link for sharing images or collection data between the first and second users based on the similarity score. However, this method does not address maintaining a secure environment and matching semantic information to provide a more efficient process. Transmitting personal data among computing devices is also known, for example as taught in U.S. Pat. No. 7,653,302.

Storage systems available on a network are also known and commercially available. Since many consumers eventually create image collections of thousands or tens of thousands of images, a large amount of storage is needed. However, none of these systems provide a simple, low cost, and straightforward system or method for interacting with, managing, storing, and controlling digital images in a distributed consumer environment. Such networks do not overcome the challenges of prior-art digital imaging systems, particularly in a distributed system with remote locations. In general, users find the interactive use of computers for receiving, storing, viewing, and using their images to be complicated, tedious, and expensive, with many bathers to access, particularly for mobile digital cameras.

Although digital image collections pose new problems for digital photographers, digital imaging systems provide new capabilities, including replication, electronic display, remote access through computer networks, and the ability to analyze digital images by a computer and associate data with digital images in a database. In particular, metadata that describe digital images can enable image understanding and application in new, useful, and interesting ways. U.S. Patent Publication 2009/0192967 discusses metadata extracted from digital images and image collections and categorizing relationship of individuals in a collection of images to infer social relationships. However, users resist providing metadata about images because the work is tedious and can be difficult. Automated metadata generation, for example by computer analysis of images, can be slow and error prone.

There is a need therefore, for an improved system and method for reducing the effort and improving the accuracy of metadata in digital image systems.

### SUMMARY OF THE INVENTION

In accordance with the present invention, there is provided a system for storing digital images and accessing and storing digital image information using a communication network, comprising:

a plurality of independently controlled digital storage repositories for storing digital images, each digital storage repository having a processor and an associated computer program, connected to the communication network, and wherein each digital storage repository is associated with one or more different authorization groups, each authorization group enabling access by the digital storage repositories within the authorization group to the digital storage repositories within the authorization group;

wherein each processor of each digital image repository uses its computer program to store and retrieve over the communication network semantic information derived from the digital images and categories associated with the derived semantic information, to match semantic information from other digital storage repositories in a common authorization group, and to associate a category with matched semantic information;

wherein a first digital storage repository includes a first digital image with associated first semantic information and wherein a second digital storage repository in a common authorization group with the first digital storage repository includes a second digital image with associated second semantic information and an associated second category; and

wherein the processor of the first digital storage repository uses its computer program to independently access and match the first semantic information with the second semantic information, to associate the second category with the first semantic information, and to store the second category in association with the first semantic information in the first digital storage repository.

The present invention provides improved convenience and simplicity for users of digital imaging systems with distributed storage devices. Communication between storage devices together with multiple processors for analyzing images and distributing metadata are enabled with security and simplicity in a highly distributed environment that provides mobility, storage, convenience, and security to persons of digital image collections.

### BRIEF DESCRIPTION OF THE DRAWINGS

The above and other features and advantages of the present invention will become more apparent when taken in conjunction with the following description and drawings, wherein identical reference numerals have been used, where appropriate, to designate identical features that are common to the figures, and wherein:

FIG. 1A is an illustration of a digital image system including a digital camera and a storage device with a wireless local communication channel according to an embodiment of the present invention;

FIG. 1B is an illustration of a digital image system including a digital camera and a storage device with a wired local communication channel using a dock according to an embodiment of the present invention;

FIG. 2 is a front perspective, a back perspective, and a schematic of a digital camera according to an embodiment of the present invention;

FIG. 3 is a perspective and a schematic of a storage device according to an embodiment of the present invention;

FIG. 4A is an illustration of a digital image system including a digital camera, a storage device, and a computer according to another embodiment of the present invention;

FIG. 4B is an illustration of a digital image system including a digital camera, a storage device, and a computer according to an alternative embodiment of the present invention;

FIG. 4C is an illustration of a digital image system including a digital camera, a storage device, and a computer according to yet another embodiment of the present invention;

FIG. 4D is an illustration of a digital image system including a digital camera, a storage device, and a computer according to another embodiment of the present invention;

FIG. 5A is an illustration of a digital image system including a digital camera, two storage devices, and a computer according to another embodiment of the present invention;

FIG. 5B is an illustration of a digital image system including two digital cameras, a storage device, and a computer according to another embodiment of the present invention;

FIG. 6 is an illustration of a stacked group of three storage devices according to another embodiment of the present invention;

FIG. 7 is a flow diagram illustrating various methods of the present invention;

FIG. 8 is a flow diagram illustrating a method of the present invention;

FIG. 9 is a schematic of a system according to an embodiment of the present invention;

FIGS. 10A-10D are sequential database illustrations of information useful in an embodiment of the present invention; and

FIG. 11 is a flow diagram illustrating a method of the present invention.

### DETAILED DESCRIPTION OF THE INVENTION

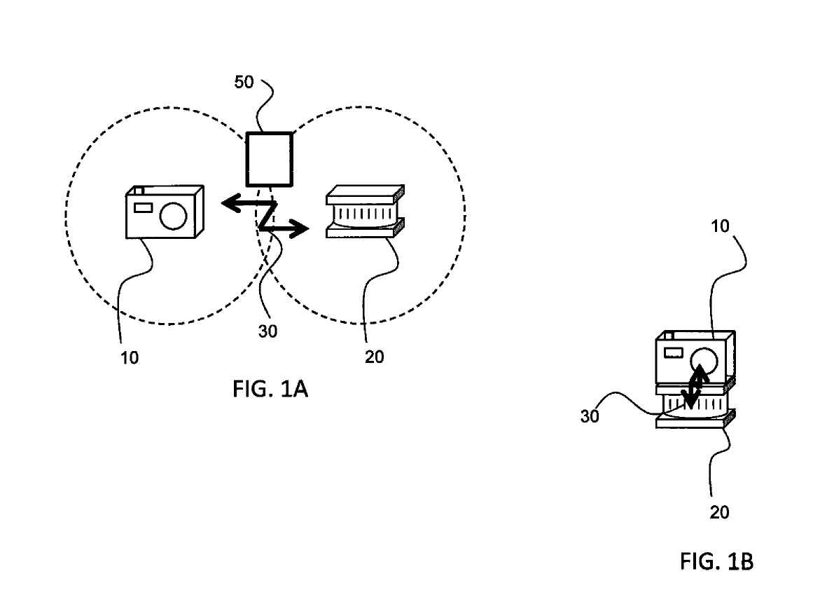

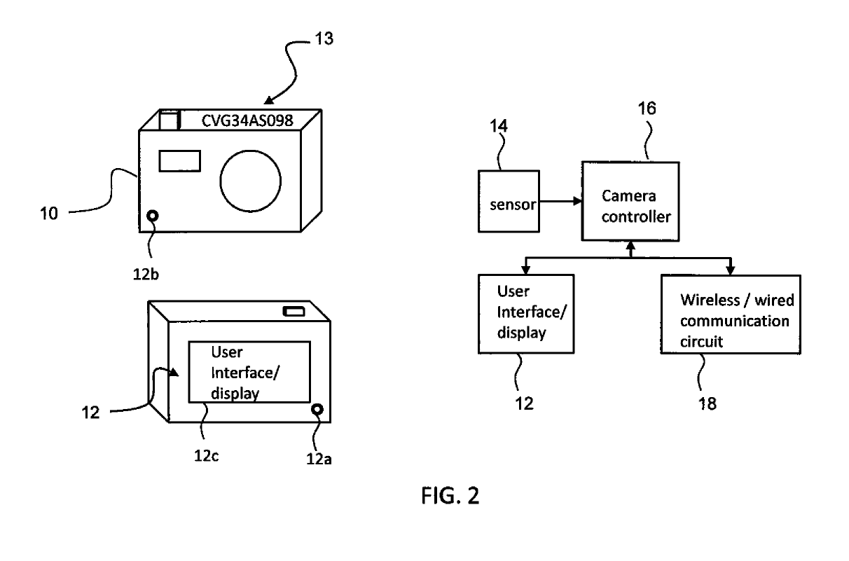

Referring to FIG. 1A, a digital image system according to an embodiment of the present invention includes a digital camera 10 and a storage device 20 physically separate from the digital camera 10. The storage device 20 can be a non-image-display device that does not include a display for displaying information stored in the storage device 20. The digital camera 10 and the storage device 20 interact through a local communication channel 30 to communicate information 50, for example digital images. The local communication channel 30 can be a wireless local area network (WLAN), for example a WiFi LAN or a Bluetooth point-to-point wireless connection. Alternatively, as shown in FIG. 1B, the local communication channel 30 can be a camera dock in which the dock is integrated with the storage device 20 to provide a wired, releasable electrical connection for communication and for charging. Alternatively, docks can employ an inductive connection for communication or battery charging. Camera docks are known in the art, for example Eastman Kodak sells such docks. In FIG. 1A, the dashed circles represent electromagnetic radiation communication to or from the device within the dashed circle. Physically separate devices can be connected or disconnected with a physical connector or can require an inter-device connection to communicate. For example, two physically separate devices can be in completely different geographic locations and communicate through the internet or an intermediate server.

Referring further to FIG. 2, the digital camera 10 includes an image sensor 14 such as a CCD- or CMOS-type image sensor for use in capturing digital images 50. For example, the term digital camera includes image-capture devices such as mobile or cellular phones including image-capture devices, independent digital cameras, and embedded digital cameras. The digital camera 10 includes a camera communication circuit 18, either wireless or wired, for receiving and transmitting information and digital images 50, a user interface 12 for interacting with a user of the digital image system, and a digital camera controller 16 for controlling the image sensor 14, the camera wireless communication circuit 18, and the user interface 12. The user interface 12 can include an image display and control switches (not shown). In one embodiment of the present invention, the user interface includes a touch screen 12c, a microphone 12b, and a speaker 12a. The digital camera 10 can include a camera identifier 13 that can be electronically stored within the digital camera 10. Image sensors 14, digital camera controller 16, camera communication circuits 18, displays, switches, and touch screens employed in user interfaces 12 are known in the electronic and computing arts. As used herein, digital images refer to still images, image sequences, video sequences, groups of images, or any multi-media element that includes images. These digital images are stored in a variety of known digital file formats, such as the JPEG or MPEG file formats.

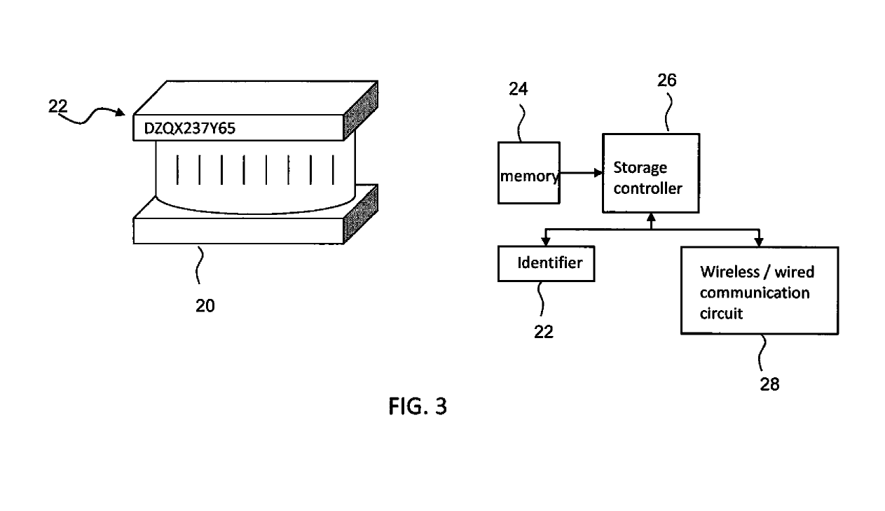

Referring to FIG. 3, the storage device 20 physically separate from the digital camera 10 includes a storage memory 24 for storing digital images 50, a storage identifier 22 that can be electronically stored within the storage device 20, a storage communication circuit 28 that communicates with the camera communication circuit 18 (FIG. 2), in either a wired or wireless fashion, and a storage controller 26 for controlling the storage memory 24 and the storage communication circuit 28, the storage controller 26 enabling access to the storage memory 24 from a device that communicates the storage identifier 22. The storage device 20 can, but in a preferred embodiment does not, include an image-capable display. Storage controller 26, storage communication circuits 28, memory (e.g.

solid-state memories or disks) are known in the electronic and computing arts, as are values stored electronically or optically in memories.

Referring to FIGS. 1, 2, and 3 together, the digital camera controller 16 is operable to receive and store the storage identifier 22 with the user interface 12 in the digital camera 10 and to communicate the storage identifier 22 to the storage device 20 as identification to enable access to the storage memory 24. The camera communication circuit 18 is operable to transfer digital images to the storage device 20 and the communication storage circuit 28 is operable to receive digital images 50 from the digital camera 10 and store the received digital images 50 in the storage memory 24. The camera identifier 13 and storage identifier 22 can be stored in either or both the digital camera 10 and storage device 20 and can be used to create an association between particular digital cameras 10 and storage devices 20 and to provide identification when transferring, receiving, or storing information.

The storage device 20 is separate from the digital camera 10. As intended herein, devices that are separate from one another can be physically disconnected and operated separately and remotely. The devices can communicate wirelessly within, for example, the same room, area, or building or through a wired connection, for example provided in a camera dock. When the devices are remote from each other, they can also remotely communicate through an extended computer communication network such as the internet.

If the storage device (e.g. 20) is a storage device that does not have a display capable of displaying digital images 50, a user can see a digital image 50 stored in the storage device 20 by transferring and displaying the digital image 50 to another device having an image display (e.g. digital camera 10) before, after, or during a transfer of the digital image 50 to the storage device 20. Alternatively, another device having an image-capable display can communicate with the storage device 20 and display a digital image 50 communicated from the storage device 20. According to an embodiment of the present invention, the digital camera 10 is operable to communicate with the storage device 20, transmit digital images 50 to and receive digital images 50 from the storage device 20, and display digital images 50 on the user interface 12. Hence, the storage controller 26 and the digital camera controller 16 are operable to transfer digital images 50 from the digital camera 10 to the storage memory 24 of the storage device 20. Likewise, the storage controller 26 and the digital camera controller 16 are operable to transfer digital images 50 from the storage memory 24 of the storage device 20 to the digital camera 10. The user interface 12 can display digital images 50 in the digital camera 10, whether acquired by the digital camera 10 or communicated from another device such as the storage device 20. Transmitted information can include a variety of information types, for example digital images 50, handshake signals, verification and security codes, device identifiers, user identifiers, network codes, web-site addresses, and internet protocol addresses.

The user interface 12 can include a wide variety of features. For example in one embodiment, the user interface 12 receives voice input via microphone 12b and the digital camera controller 16 recognizes information from the voice input.

According to an embodiment of the present invention, the user interface 12 is operable to control digital images 50 stored in the storage memory 24. By entering information through the user interface 12, a user can, for example, organize digital images, upload digital images, download digital images, edit, modify, and view digital images. Digital images can be named, renamed, moved from one location to another in a file hierarchy, transmitted, duplicated, and deleted. In an embodiment of the present invention, the user interface 12 on the digital camera 10 remote from the storage device 20, can serve to control a digital-image storage software utility, e.g. a storage operating system, through the camera and storage communication circuits 18, 28 and camera and storage device controllers 16, 26.

According to various embodiments of the present invention, the camera and storage communication circuits 18, 28 are implemented in a variety of ways. In one embodiment, a point-to-point wireless interface, for example Bluetooth, is employed that enables direct, two-way communication between the storage device 20 and the digital camera 10. In an embodiment, the communication is enabled when the digital camera 10 and the storage device 20 are in proximity to each other, so that when the devices are no longer near each other, wireless communication does not occur. In another embodiment of the present invention, the camera and storage communication circuits 18, 28 implement a wireless local area network, such as a WiFi network, to provide a local communication channel and communicate information between the digital camera 10 and storage device 20. In yet another embodiment of the present invention, the camera and storage communication circuits 18, 28 implement an electrically connected interface through a docking structure associated with the storage device 20 and that physically receive the digital camera 10 to provide a local communication channel and communicate information between the digital camera 10 and storage device 20.

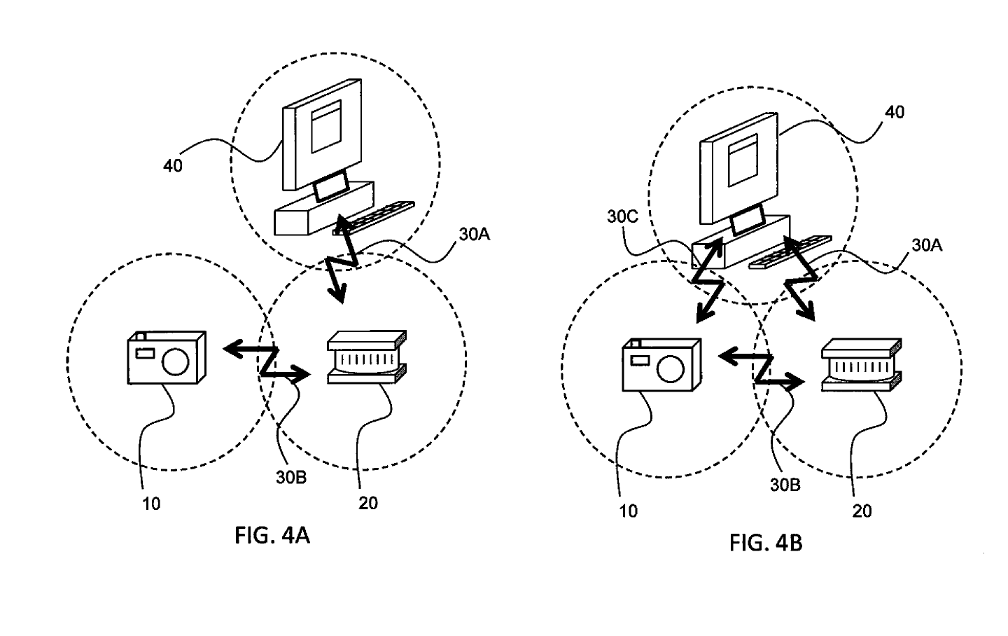

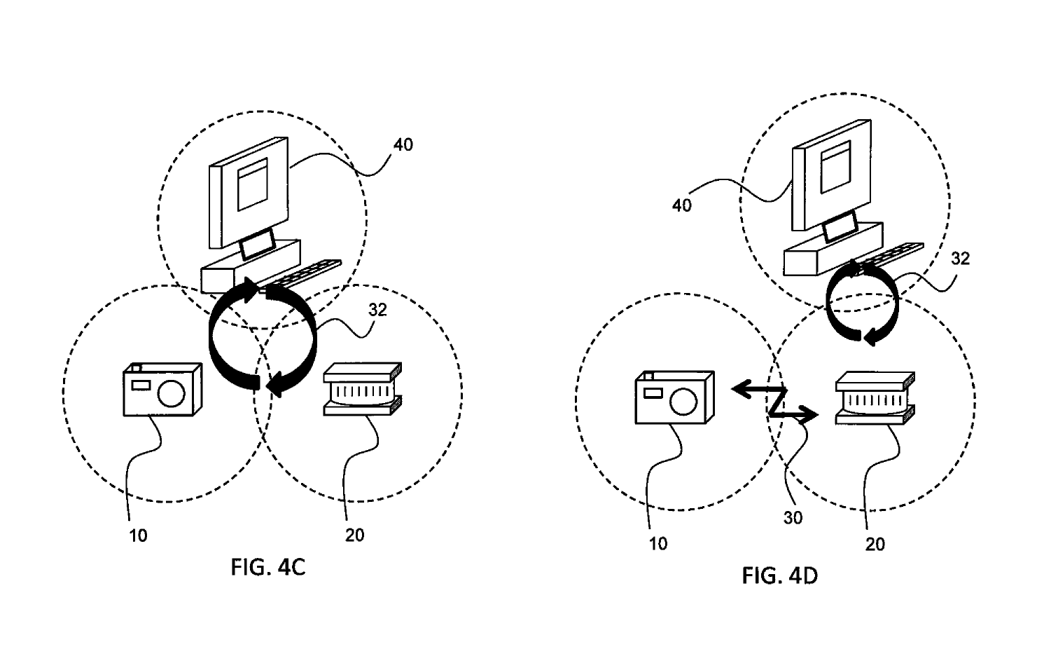

Referring to FIGS. 4A and 4B, point-to-point wireless communications between the storage device 20, the digital camera 10, and other devices are provided. As shown in FIG. 4A, a general-purpose computer 40 is provided with a point-to-point wireless communication to the storage device 20 (but not the digital camera 10) through a wireless communication channel 30A. The storage device 20 has a separate point-to-point wireless communication to the digital camera 10 through a wireless communication channel 30B. Alternatively, as shown in FIG. 4B, a general-purpose computer 40 is provided with a point-to-point wireless communication to the storage device 20 through a wireless communication channel 30A and a separate point-to-point wireless communication to the digital camera 10 through a wireless communication channel 30C. The storage device 20 has a separate point-to-point wireless communication to the digital camera 10 through a wireless communication channel 30B.

Referring to FIG. 4C, in another embodiment of the present invention, the wireless communication forms a local communication network 32 to which multiple devices are connected. In an embodiment, the communication network 32 is controlled by the digital camera 10 or the storage device 20, or a network router (not shown) and can include a network router integrated with the digital camera 10 or the storage device 20, or can include a network router separate from the digital camera 10 or storage device 20. In this embodiment, the devices (digital camera 10, storage device 20, and computer 40) can communicate with each other in a single, common local communication network 32. In an embodiment in which the wireless communication forms a local communication network 32, both the digital camera 10 and the storage device 20 are wirelessly connected to the same local communication network 32, and other devices, for example general-purpose computers 40, can also be wirelessly connected to the local communication network 32.

In an alternative embodiment of the present invention illustrated in FIG. 4D, different or additional communication structures are employed. In one embodiment, the storage device 20 communicates with a direct, point-to-point local communication channel 30 with the digital camera 10. At the same time, in an embodiment a local communication network 32 is connected to the storage device 20, for example to a general-purpose computer 40, but not to the digital camera 10. The local communication network 32 connected to the storage device 20 can be a wired connection, e.g. through an Ethernet cable, or a wireless communication network, e.g. a WiFi network or a cellular network. In either of these two cases, additional devices are connected to the local communication network 32, for example routers and general-purpose computers 40. Thus, in such an embodiment, the digital camera 10 is not directly accessed by the local communication network 32. In various embodiments, therefore, the local communication network 32 serves to connect the digital camera 10 to the storage device 20 and are a direct point-to-point wired connection, a wired network, a direct point-to-point wireless connection, or a wireless network connection.

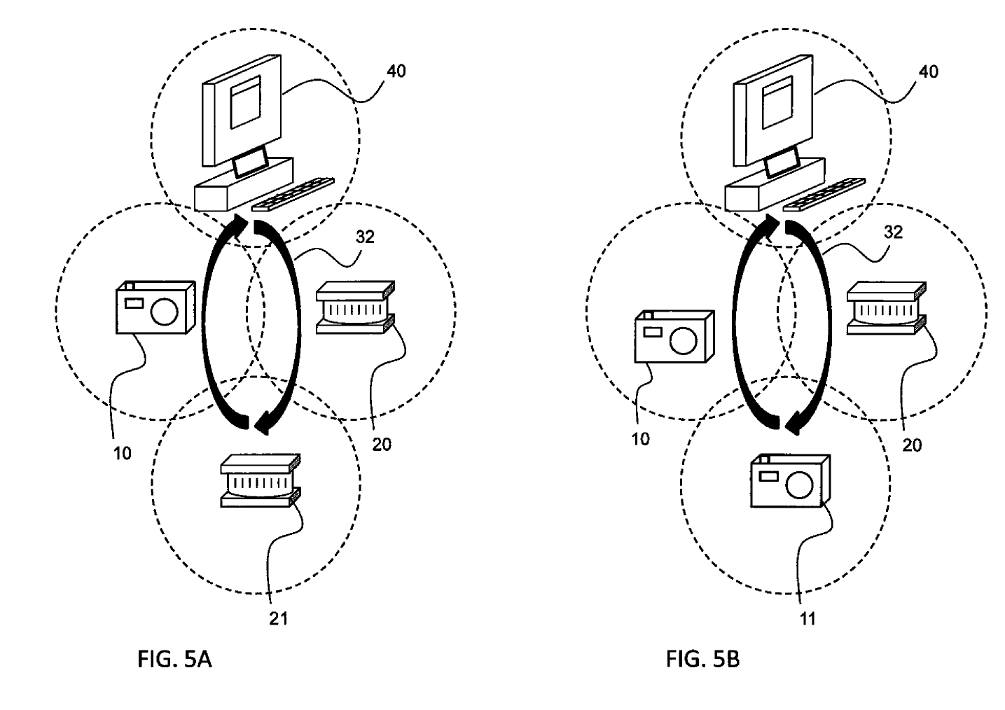

Referring to FIG. 5A, in a further embodiment of the present invention, a second storage device 21 is employed. The second storage device 21 can communicate directly with the digital camera 10 or with the storage device 20, or both. In particular, in this embodiment of the present invention, the two storage devices 20, 21 communicate with each other to provide useful digital image storage functions, for example, one storage device (e.g. 21) can serve as a back-up to the other (e.g. 20). Alternatively, one storage device (e.g. 21) can increase the digital-image storage available to the digital camera 10. By providing suitable storage device software and intercommunication between the storage devices, a single storage system and file structure are provided to the digital camera 10.

As noted above, a single digital camera 10 can employ multiple storage devices 20. Referring to FIG. 5B, in an alternative embodiment of the present invention, a single storage device 20 can communicate with multiple digital cameras 10. Thus, a digital system according to an embodiment of the present invention, can further include a second digital camera 11 remote from the storage device 20, the second digital camera 11 including a second image sensor 14 for acquiring digital images 50, a second camera communication circuit 18 for receiving and transmitting information and digital images 50, a second user interface 12, and a second digital camera controller 16 for controlling the second image sensor 14, the second camera communication circuit 18, and the second user interface 12. The second digital-camera controller 16 is operable to receive and store the storage identifier with the user interface 12 in the second digital camera 11 and to communicate the storage identifier to the storage device 20 to enable access to the image storage. The second camera communication circuit 18 is also operable to transfer digital images 50 to the storage device 20 and the communication storage circuit is operable to receive digital images 50 from the second digital camera 11 and store the received digital images 50 in the storage memory 24. Hence, in this embodiment multiple digital cameras 10, 11 employ a common storage device 20 to communicate, receive, and store digital images 50.

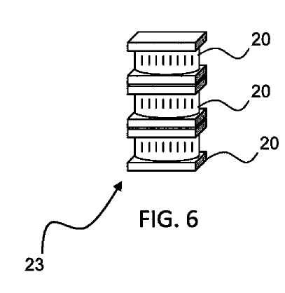

Referring to FIG. 6, in further embodiments of the present invention, a plurality of storage devices 23 are employed to increase the digital-image storage capacity of the digital image system. The storage devices 20 can communicate through communication networks or point-to-point communications as described above and can use either a wired or wireless communication.

If one or more storage devices 20 are accessible to a computer network, other devices on the computer network can likewise access the storage devices 20 to read, write, modify, or organize digital images 50. If the local communication network 32 is connected to a remote communication network 34 such as the internet, storage devices 20 can be provided with internet protocol addresses and suitable web-hosting software, or accessibility software in combination with other web sites, to provide access to the storage devices 20 over the internet. Thus, digital images 50 are controlled from external computers or are controlled from digital cameras 10 that are connected to the internet but are not within range of a wireless connection to a storage device 20.

In further embodiments of the present invention, the storage device 20 has an associated storage identifier 22, as illustrated in FIG. 3. The use of a storage identifier 22 provides additional control to users of the digital image system. In one embodiment, only devices that provide the storage identifier 22 to the storage device 20 can control digital images to be stored, retrieved, or organized in the storage device 20. A variety of storage identifiers 22 are employed in various embodiments of the present invention. For example, in one embodiment, the storage identifier 22 is electronic and is stored as data within the storage device 20. The storage identifier 22 can also, or in addition, be written in characters, images, or icons on a visually readable medium associated with the storage device 20. For example, in various embodiments a storage identifier 22 is printed on a sticker affixed to the storage device 20 or printed on a sticker affixed to packaging material or documentation associated with the storage device 20. In another embodiment, the storage identifier 22 is engraved on the storage device 20 or on a plate or other medium permanently attached to the storage device 20. In yet another embodiment, a storage identifier 22 is printed on a medium that is removable from the storage device 20.

In embodiments of the present invention, the storage identifier 22 is used by the digital camera 10 to provide secure access to the storage device 20. The storage identifier 22 is associated with the digital camera 10 in various ways. For example, in one embodiment the user interface 12 is operable to manually enter the storage identifier 22 and a digital camera user interacts with the user interface 12 to enter the storage identifier 22 to the digital camera controller 16. The digital camera controller 16 can then communicate the storage identifier 22 to the storage device 20 to demonstrate to the storage device 20 that the digital camera 10 has access privileges to the storage device 20. In another embodiment, the storage identifier 22 is communicated wirelessly from the storage device 20 to the digital camera 10. If close proximity is needed to establish wireless communication, this can be adequate to provide security to the digital camera or storage device user. However, in other embodiments, it is preferred to require a manual interaction to accept the wirelessly received storage identifier 22 so that other devices that are inadvertently within wireless communication range are not inappropriately connected or confused. A user can answer a question or take a specific action with the user interface 12 to indicate the connection between the digital camera 10 and the storage device 20 (e.g. make a selection with a touch screen on a display). In one embodiment, physically docking a digital camera 10 on a storage device 20 can provide access privileges for storing transferred information.

Storage identifiers 22 can be alphanumeric sequences or strings, as shown in FIG. 3. Alternatively, storage identifiers 22 can be images or graphic symbols such as icons. In one embodiment of the present invention, the digital camera 10 is used to take a photograph of the storage identifier 22 and the digital camera controller 16 is operable to analyze the photograph and extract the storage identifier 22. In various embodiment, the storage identifier 22 is alphanumeric, an icon or image, or an encoded icon or image such as a one-dimensional or two-dimensional barcode.

Once communicated to the digital camera 10, the storage identifier 22 is stored in the digital camera 10 and used thereafter to communicate with the storage device 20, for example to use the storage device 20 as a repository for digital images 50 acquired by the digital camera 10. If the storage identifier 22 is not initially stored electronically in the storage device 20, it is communicated to the storage device 20 and then stored. In many embodiments of the present invention, it is useful to maintain security for the digital camera 10, the storage device 20, and any information stored in the storage device 20. Therefore, in some embodiments of the present invention, a security code is employed. The storage identifier 22 is employed as a security code, if it is communicated securely. In other embodiments, the security code is supplementary. The security code can originate from the storage device 20, the digital camera 10, or be chosen by a user, for example in a fashion similar to the use of passwords. If chosen by a user, the security code is entered through the user interface 12 by the user. As with the storage identifier 22, a security code is an alphanumeric sequence or an image or icon, or other forms of information. In various embodiments, the security code is stored within the digital camera 10, the storage device 20, or both the digital camera 10 and the storage device 20, or is received from the storage device 20 and is stored within the digital camera 10. The security code is entered each time there is a communication between the digital camera 10 and storage device 20 or is automatically employed, once entered, for each communication, or some communications or actions can require that a security code be employed although other communications or actions do not.

When multiple storage devices 20 or multiple cameras 10 are employed in an embodiment of a digital image system of the present invention, a common security code or the same storage identifier 22 is employed by the multiple digital cameras 10 or storage devices 20. In one embodiment of the present invention, control access to the digital images 50 stored in the storage device 20 is provided equally from multiple digital cameras 10. In other embodiments, other digital cameras 10 can have restricted privileges with respect to the storage device 20. This latter embodiment, for example, is useful if one digital camera 10 is operated by an adult and others are operated by children or those less skilled in managing digital-image collections.

Security codes for network access can also be provided for digital cameras 10 or for storage devices 20. According to an embodiment of the present invention, a digital image system includes a digital camera 10 including an image sensor 14 for acquiring digital images 50, a camera communication circuit 18 for receiving and transmitting information and digital images 50, a user interface 12, and a digital camera controller 16 for controlling the image sensor 14, the camera communication circuit 18, and the user interface 12. A storage device 20 remote from the digital camera 10 includes a storage memory 24 for storing digital images 50, a storage identifier 22, a storage communication circuit 28 that communicates with the camera communication circuit 18, and a storage controller 26 for controlling the storage memory 24 and the storage communication circuit 28, the storage controller 26 enabling access to the storage memory 24 from a device that communicates the storage identifier 22. The digital camera user interface 12 and digital camera controller 16 operate to provide a network access code for a wireless network to the storage device 20. The storage device 20 is responsive to the network access code to access the network.

According to an embodiment of a method of the present invention, a digital camera 10 including an image sensor for acquiring digital images 50, a camera communication circuit 18 for receiving and transmitting information and digital images 50, a user interface 12, and a digital camera controller 16 for controlling the image sensor 14, the camera communication circuit 18, and the user interface 12 are provided. A storage device 20 remote from the digital camera 10 is provided that includes a storage memory 24 for storing digital images 50, a storage communication circuit 28 that communicates with the camera communication circuit 18, and a storage controller 26 for controlling the storage memory 24 and the storage communication circuit 28. The camera communication circuit 18 is operable to transfer digital images 50 to the storage device 20 and the storage communication circuit 28 is operable to receive digital images 50 from the digital camera 10 and store the received digital images 50 in the storage memory 24 and the user interface 12 is operable to control digital images 50 stored in the storage memory 24. In a further embodiment of the present invention, the storage device 20 is provided with a storage identifier 22. The digital camera controller 16 is operable to receive and store the storage identifier 22 with the user interface 12 in the digital camera 10 and to communicate the storage identifier 22 to the storage device 20 to enable access to the storage memory 24.

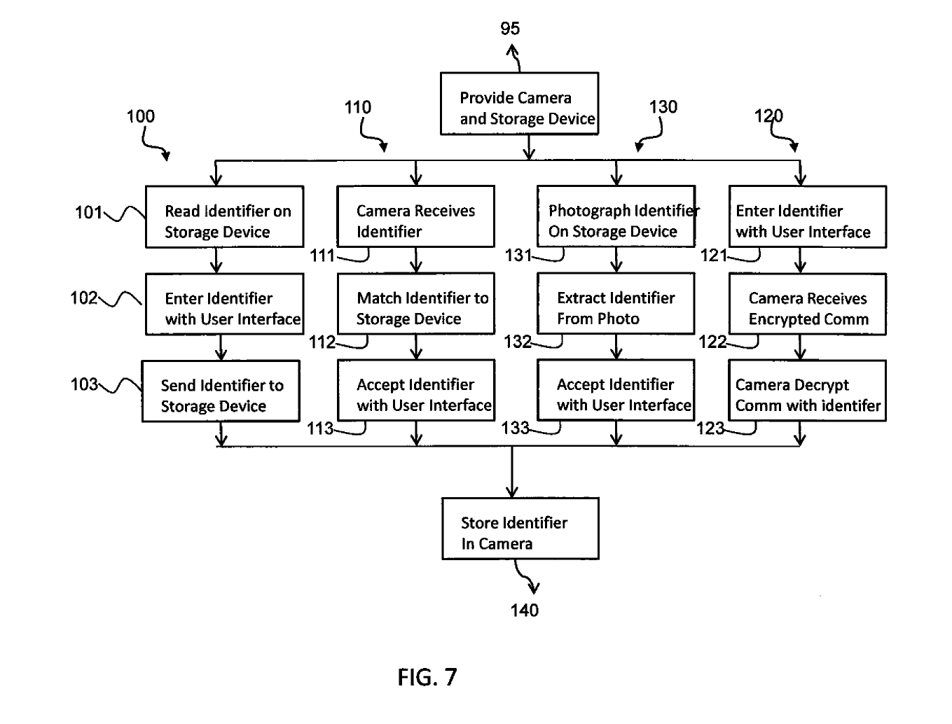

A variety of methods are employed in various embodiments to enable the present invention. Referring to FIG. 7, a variety of embodiments is illustrated. In FIG. 7, one of the paths (100, 110, 120, or 130) is used to provide and communicate the storage identifier 22 once the camera and storage devices are provided (step 95). In one embodiment, illustrated as path 100, a storage device 20 is provided with a printed storage identifier 22 and read (step 101), for example on the storage device 22 or a medium associated with the device. A digital camera 10 with a user interface 12 is separately provided and the storage identifier 22 manually entered into the digital camera 10 (step 102). The wireless storage device 20 receives a communication with the storage identifier 22 to establish a secure communication (step 103). In this embodiment, the communication is preferably a wired or short-distance wireless communication so that other digital camera operators do not inappropriately communicate with the storage device 20. Once the storage device 20 has received and stored the storage identifier 22, a secure communication interface is established.

In another embodiment illustrated as path 110, a storage identifier 22 is stored in the storage device 20. The storage identifier 22 is wired or wirelessly communicated to the digital camera 10 and stored (step 111). The received storage identifier 22 is matched to a human-readable storage identifier 22 printed on or with the storage device 20 or storage device packaging that is accessible to the appropriate digital image system user only (step 112). In one embodiment, to ensure that a digital camera user desires to interact with the storage device 20, the user is required to manually enter an acceptance into the user interface 12 to accept or acknowledge the storage device 20 and storage device interactions (step 113). Again, in this embodiment, any wireless communication is preferably a short-distance communication so that other digital camera operators do not inappropriately communicate with the storage device 20. The storage identifier 22 can also be encoded as a photograph or image (step 131) used or matched directly to provide identification or an identifier is extracted (step 132 e.g. by optical character recognition) from the image and accepted with the user interface 12 (step 133 in path 130).

Once the storage identifier 22 is provided, the storage identifier 22 is stored in the digital camera 10 (step 140) and, if needed, in the storage device 20. In another embodiment illustrated as path 120, the storage identifier 22 is stored in the storage device 20 and provided on a printed medium. The storage identifier 22 is entered into the digital camera 10 (step 121). The storage identifier 22 serves as a key to encrypt communications (step 122) between the storage device 20 and the digital camera 10. Since both devices have the same key, the communication is decrypted by the receiver to establish communication (step 123). Alternatively, the storage identifier 22 is entered into the digital camera 10 before the camera receives the encrypted communication. In yet another embodiment, after the storage identifier 22 is entered into the digital camera 10, the camera sends an encrypted communication to the storage device 20.

To provide further security, a security code is communicated, for example a security code selected by the user, and employed in communications between the storage device 20 and the digital camera 10. The storage identifier 22 and security code is entered into the digital camera 10 through the user interface 12. Furthermore, communications can be encrypted, for example by using the identifier or the security code as an encryption key. Thus, an individual that inappropriately receives wireless communications between the digital camera 10 and the storage device 20 is not able to understand the communication. In one example of the present invention, the storage identifier 22 is stored in the storage device 20, provided on or with the storage device 20 in human-readable form, and then separately entered into the digital camera 10. The storage device 20 and the digital camera 10 then communicate with an encrypted communication that is encrypted using the storage identifier 22 as a key. Since both the digital camera 10 and the storage device 20 use a common encryption key, they can decrypt the communication and communicate. Any other device that intercepts the communication cannot decrypt the communication. Unless unauthorized access is obtained to the human-readable storage identifier 22 associated with the storage device 20, this method will provide a secure interaction and connection between the digital camera 10 and the storage device 20.

In another embodiment of the present invention, a second storage device 21 is added to the digital image system. In this embodiment, the initial communications between the digital camera 10 and the second storage device 21 are the same, except that a different storage identifier 22 is employed. In various embodiments, the digital camera user interface and digital camera controller 16 can operate to communicate to both or either of the storage devices 20 and the storage devices 20 can directly intercommunicate, as controlled through the digital camera user interface. Thus, one storage device can act as an extended memory or a backup to the other.

In yet another embodiment of the present invention, a second digital camera 11 is added to the digital image system. In this embodiment, the initial communications between the second digital camera 11 and the storage device 20 are the same. The storage device 20 can communicate with both digital cameras 10, 11, either separately or at the same time. In one embodiment, one digital camera is controlled to have limited access rights to the storage device 20. In another embodiment, the two digital cameras 10, 11 communicate directly.

The digital camera 10 and storage device 20 can communicate directly. In another method of the present invention, a remote communications network 34 is included in the digital image system. The remote communications network 34 can also be accessed by the storage device 20, by the digital camera 10, or by both the digital camera 10 and the storage device 20. The remote communications network 34 can be provided only to the storage device 20 and can communicate with a wireless, wired, or cellular connection. According to a further method of the present invention, the remote communications network 34 can also be connected to the internet or be the internet and the digital storage device 20 is accessed through the internet to control the digital images 50 stored on the storage device 20. Access can also be restricted to communications that employ the storage identifier 22 or the security code or both.

Because wireless networks can, in some circumstances, have limited communications capability, according to a method of the present invention, a digital camera 10 first communicates a low-resolution version of a digital image 50 and subsequently communicates a high-resolution version of the digital image 50. This can also be useful for other communication methods when bandwidth or time is limited.

In one method of the present invention, a digital camera 10 and a storage device 20 are purchased. The digital camera 10 is purchased with the storage device 20 and both the digital camera 10 and the storage device 20 electronically store the same identifier or related identifiers. Both the digital camera 10 and the storage device 20 are operable to encrypt and decrypt wireless communications with the identifier. The digital camera 10 and user interface 12 are operable to provide additional instructions to the digital system to organize the storage device storage as desired, for example for single or multiple users.

Thereafter, when the digital camera 10 and the storage device 20 are in proximity or connected to a common wired or wireless network, the digital camera 10 can interact with the storage device 20 using secure communications to store and retrieve information such as digital images 50. If a common network is used, the user interface 12 on the digital camera 10 is employed to provide access codes to the network for the digital camera 10, the storage device 20, both the digital camera 10 and the storage device 20, or only one of the digital camera 10 and storage device 20. The storage device 20 can be connected to a local communications network 32 although the digital camera 10 is not, or the digital camera 10 can be connected to a local communications network 32 although the storage device 20 is not.

In another method of the present invention, a digital camera 10 and a storage device 20 are purchased separately. The storage device 20 electronically stores an identifier and includes packaging material with the identifier provided. The digital camera 10 user interface is operated to enter the identifier into the digital camera 10. Both the digital camera 10 and the storage device 20 are operable to encrypt and decrypt communications with the identifier. The digital camera 10 interacts with the storage device 20 using the identifier to establish a connection between the digital camera 10 and the storage device 20. The digital camera 10 and user interface 12 are operable to provide additional instructions to the digital system to organize the storage device storage as desired, for example for single or multiple users. Thereafter, communications between the storage device 20 and the digital camera 10 can proceed as described above. Network access can be provided as described above.

If additional digital cameras 10 are desired to operate with the same storage device, the same process is followed as described above, using the storage identifier 22. If an additional storage device is desired, the additional identifier is provided to the digital camera 10 and communications established between the digital camera 10 and the additional storage device 20. In one embodiment of the present invention, the digital camera controller 16 and the two storage controllers 26 interoperate to organize the storage in the two storage devices as a unified storage system, as desired, for example as backup, as a single extended storage space, to manage storage for multiple users, or to manage storage for multiple cameras. The storage space can also be organized to provide separate storage for each of multiple users. Each user can have a single logical storage space that is distributed across multiple storage devices 20.

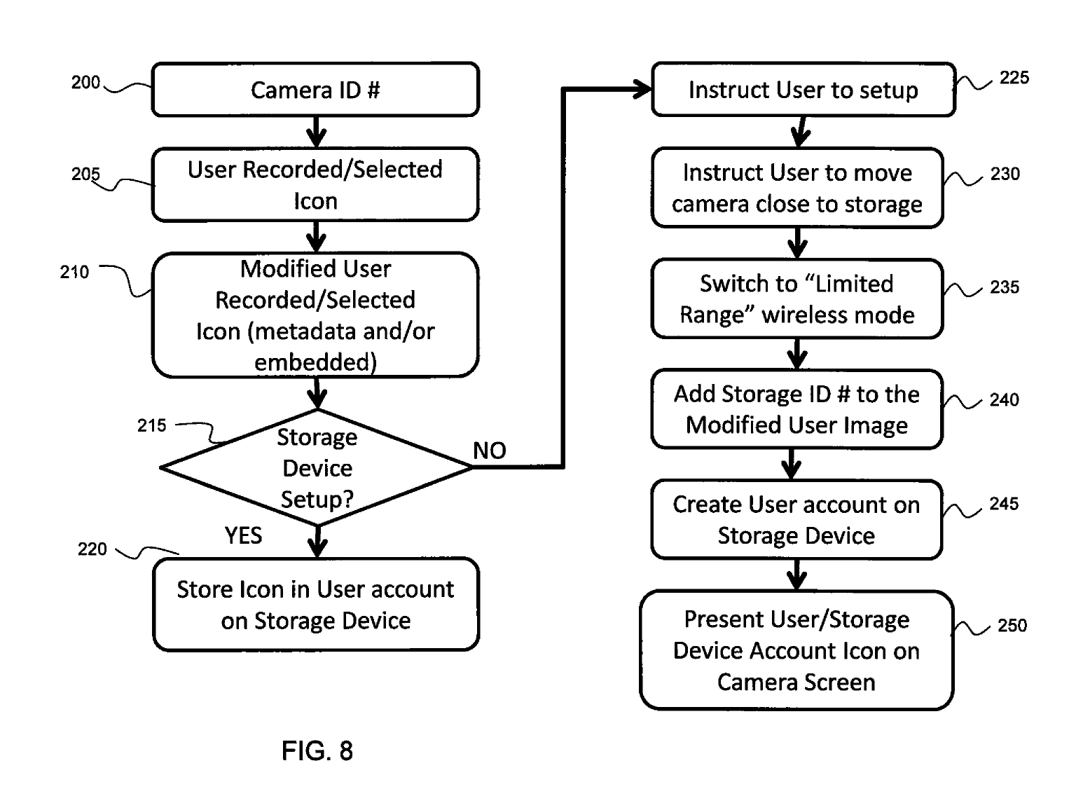

Referring to FIG. 8, in another example of one embodiment of the present invention, a graphic symbol or image is used as the identifier. FIG. 8 illustrates a process of selecting and assigning an identifier to a digital camera and storage device system. In step 200, the digital camera 10 identification is assigned. This assignment is made at production or an identifier is provided by a user, for example through the user interface 12. In step 205, an image, graphic symbol, or icon is taken, made, or selected. For clarity in this example, the image, graphic symbol, or icon will be referred to as an icon. In step 210, the icon is modified or processed to be a suitable size and to include any useful characteristic required by the digital camera 10 or storage device 20, for example file size and format. Metadata can also be associated with the icon and stored with it, for example in the header of an image file or embedded in the image. The status of the storage device 20 is checked in step 215. If the storage device 20 is already properly associated with the desired camera and user and the desired storage structures are organized, the icon is transmitted to the storage device 20 and stored in the storage device 20 and associated with the user (step 220). Thereafter, when the digital camera 10 interacts with the digital camera 10, the icon is used as a mutual identifier to provide security in storage and communications.

If the storage device 20 is not yet organized, for example the first time the devices are started, the user is instructed to set up the system in step 225, for example by providing a message to the user through the user interface 12. The user is instructed to move the camera close to the storage device 20, for example to enable a proximity point-to-point communication or to enable wireless network access by the camera in step 230. The user can be requested to enter any network codes, if needed. In a point-to-point proximity communication, such network codes are not needed. In step 235, the user is requested to set any appropriate switches in the digital camera 10 to enable communication with the storage device 20. A storage identification code identifying the storage device 20, for example, an alphanumeric code is associated with the icon in step 240, and communicated to the storage device 20. The storage device 20 stores the icon and organizes the storage to match the digital camera request, for example by providing a user account, in step 245. In step 250, the information is presented to the user on the user interface 12 as a confirmation.

Digital cameras are typically used as mobile devices to acquire images at various different locations. Although storage devices are not necessarily similarly mobile, according to an embodiment of the present invention, storage devices are similarly mobile. In this embodiment, for example, a user can travel with both a digital camera 10 and a storage device 20 and periodically connect the digital camera through a local communication connection (e.g. a docking procedure) to transfer images from the digital camera 10 to the storage device 20.

In another embodiment, the digital camera 10 is mobile although the storage devices 20 are not necessarily mobile and are kept, for example at a user's home. In this situation, it is useful to be able to transfer images acquired by the digital camera 10 to a remote storage device 20. According to an embodiment of the present invention, this is accomplished by enabling a digital camera 10 to communicate through a local communication channel 30 to any storage device 20 that is connected to a remote communication network 34, even if the storage device 20 and the digital camera 10 are not associated with each other. By remote communication network 34 is meant a communication network 34 that is connected to two or more storage devices 20 and for which at least one of the storage devices 20 cannot be communicated with through a local communication channel 30, for example because it is not physically accessible or too far away (out of range). For example, a remote communication network 34 such as the internet can interconnect two separate and different storage devices in two different locations. Each storage device 20 is connected to a separate local communication channel 30 (e.g. a local area network). Thus, a digital camera 10 that communicates through a local communication channel 30 with one storage device 20 cannot communicate through the same local communication channel 30 with a different remotely connected storage device 20 that is remotely connected through the remote communication network 34.

In this embodiment, each digital camera 10 has one or more associated storage devices 20 and one or more storage devices that are not associated. The digital camera 10 can communicate locally to any storage device with which it is associated, as described above. Additionally, the digital camera 10 can communicate locally with any storage device 20 with which it is not associated, for example by docking the digital camera 10 with the storage device 20. When a digital camera 10 communicates locally with a non-associated storage device 20, information is transferred from the digital camera 10 to the non-associated storage device 20. However, security permissions can be different than those used for communication between associated devices, for example preventing editing, viewing, or managing images stored in the local non-associated storage device 20. The non-associated storage device 20 then forwards the received information to the storage device 20 associated with the digital camera 10 through the remote communication network 34. The associated storage device 20 receives the information through the remote communication network 34 and stores the received information.

The storage devices 20 can be functionally identical so that any storage device 20 can receive information from any digital camera 10. By functionally identical is meant that each storage device 20 can communicate with each digital camera 10 and forward information to any storage device 20, as needed. Functionally identical storage devices can differ, for example by the amount of storage or speed of interaction or transmission, and by identification.

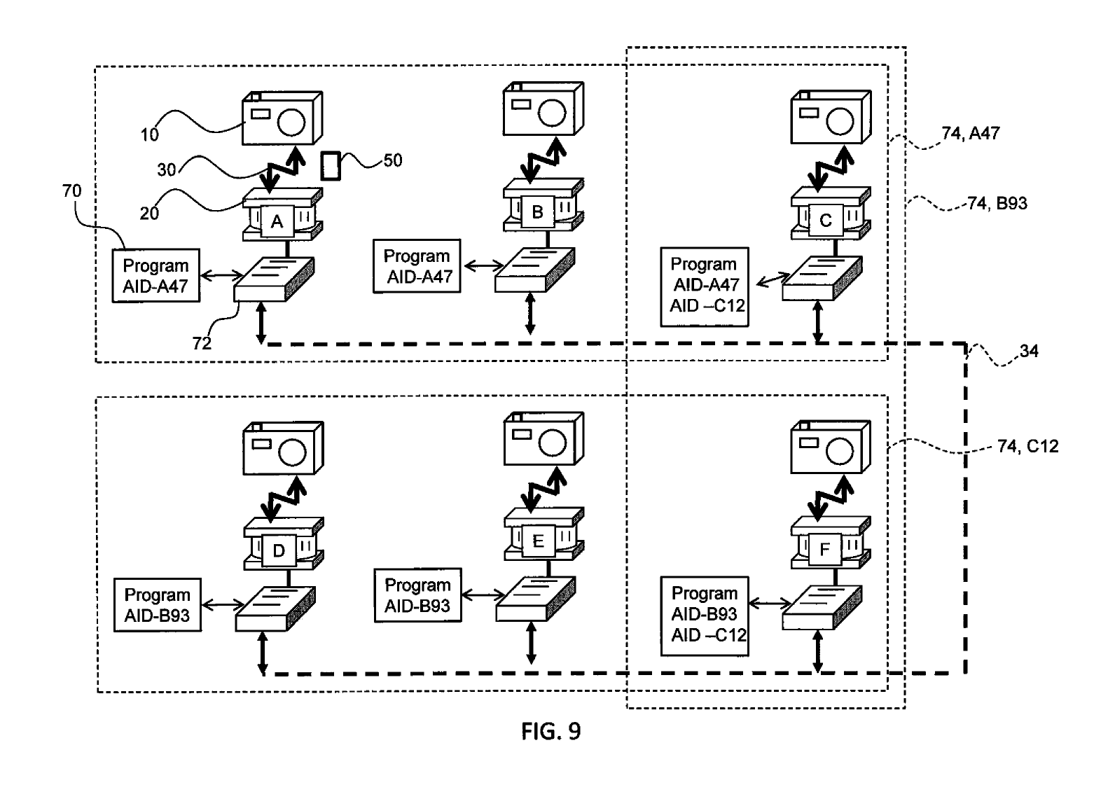

According to an embodiment of the present invention, the storage devices 20 can enable a system for storing digital images 50 and accessing and storing digital image information using a local or remote communication network 32, 34. Referring to FIG. 9, such a system can include a plurality of independently controlled digital storage repositories 20 and a computer program or programs 70 remotely connected to a communication network 34. The computer program 70 can execute on a processor 72 that is associated with or part of the storage device 20. The storage devices 20 are owned, used, or operated by different or the same persons. The digital storage repositories 20 store and retrieve digital images 50, semantic information derived from the digital images 50, and categories associated with the semantic information. In this discussion, the term digital storage repository is used to refer to a storage device having a processor capable of operating independently of other computer devices in receiving requests for information via a communications network.

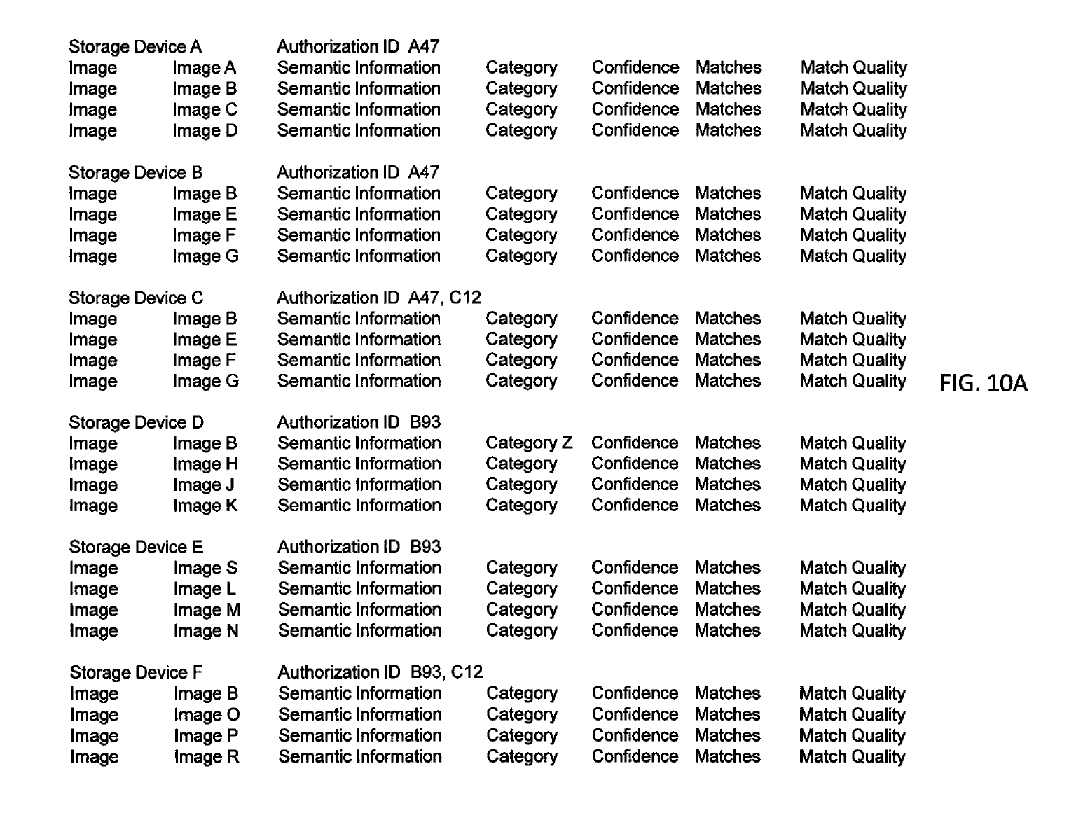

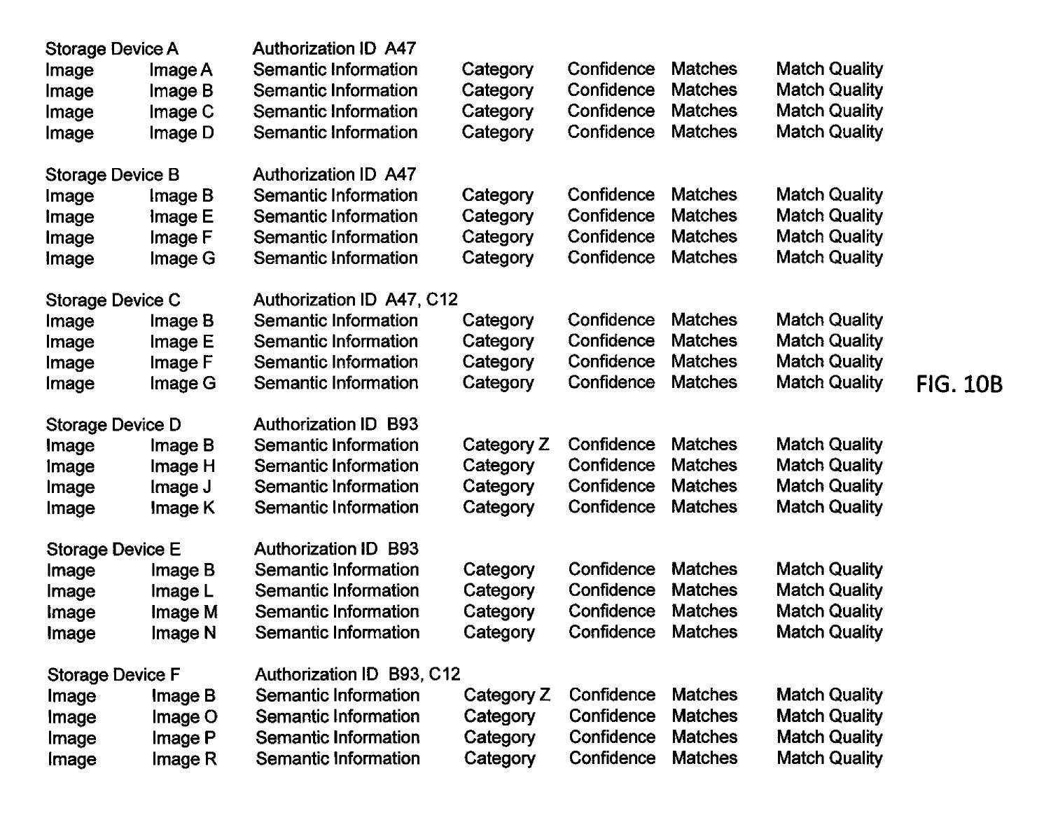

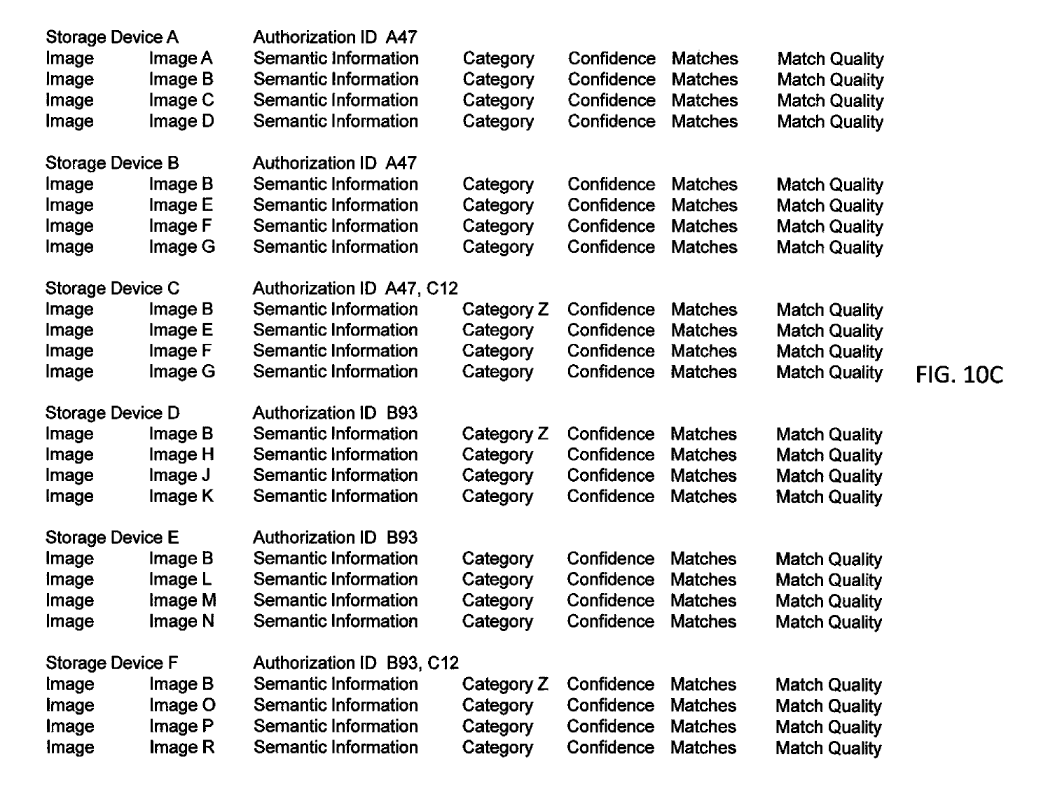

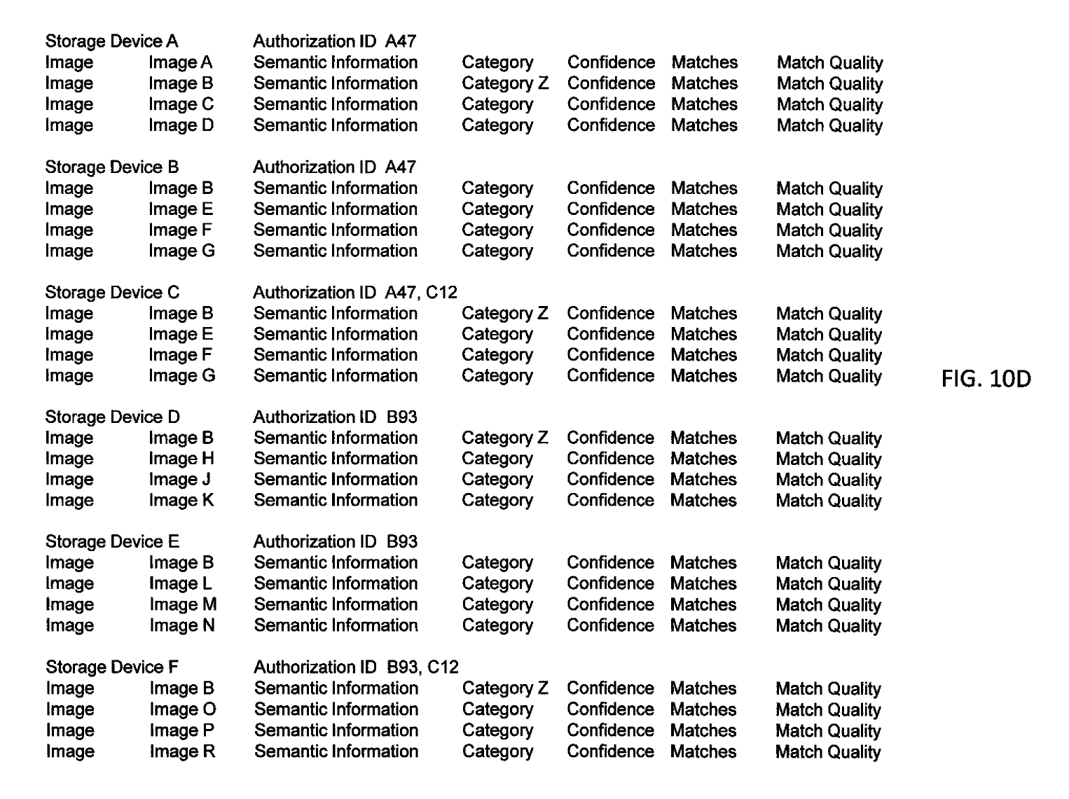

The processor 72 of each storage device 20 uses its computer program 70 to match semantic information associated with different digital images 50 and to associate a category with semantic information. Each digital storage repository 20 and the associated computer program 70 is operably part of a storage device. Computer programs, computers, storage devices, digital cameras, and network communications are known in the art. The images 50, semantic information, and categories can be stored in a conventional database likewise stored in the digital image repository, as illustrated in the database illustration of FIG. 10A.

Referring also to FIGS. 10A-10D, a plurality of different authorization groups 74 are formed and identified (e.g. Authorization identification A47, B93, C12). Each authorization group 74 enables access to one or more digital storage repositories 20 by the processor 72 using a computer program 70 of at least one digital storage repository 20. A first digital storage repository 20 includes a first digital image 50 with associated first semantic information and a second digital storage repository 20 includes a second digital image 50 with associated second semantic information and an associated second category. In FIG. 9, the authorization groups 74 are labeled with identifiers A47, B93, and C12 in FIGS. 9 and 10A-10D and the digital storage repositories 20 are labeled with identifiers A, B, C, D, E, and F. In various embodiments, each digital storage repository 20 is owned by a different person, for example digital storage repository A is owned, used, or operated by a first person, the storage repository B is owned, used, or operated by a second person. Alternatively, two storage repositories is owned, used, or operated by a single person, for example storage repositories C and D are be owned, used, or operated by a single person. The digital storage repositories 20 can be included in authorization groups that are defined by owners, users, or operators, for example by exchanging authorization identification information and providing the authorization identification information to their digital storage repositories. Digital storage repositories 20 that are part of a common authorization group have mutual permission to obtain semantic information from each other to match to their own semantic information. In an alternative embodiment of the present invention, a computer program 70 associated with one storage repository 20 can modify the semantic or category information in another different storage repository 20, given appropriate authorization.

As shown in FIG. 9, multiple authorization groups 74 are provided for multiple subsets of digital storage repositories 20. One group (e.g. authorization group C12) can include digital storage repositories (e.g. storage repository D and storage repository F) that are part of another authorization group (e.g. authorization groups A47 and B93).

The processor 72 using computer program 70 of the first digital storage repository 20 independently accesses and matches the first semantic information with the second semantic information, associates the second category with the first semantic information, and stores the second category in association with the first semantic information in the first digital storage repository 20. For example, referring to FIGS. 9 and 10A, the processor 72 using computer program 70 of digital storage repository A can access and match semantic information in digital storage repository B with its own semantic information. Both digital storage repository A and digital storage repository B are part of authorization group A47.

If a semantic information match is found, a category for the semantic information in digital storage repository B can be accessed and stored in digital storage repository A in association with the matched semantic information in digital storage repository A. (If digital storage repository A already has the information, it is not necessary to store the information again.) Generally, semantic information will match if the images in the different repositories are the same or a closely related image. For example, two images are identical and stored separately in two different digital storage repositories. Alternatively, two different images are made of the same scene at approximately the same time or under the same circumstances so that the images are closely related and very similar.

Semantic information can be based upon metadata, for example semantic information can include the location of objects, for example the position of a face in an image. A category provides additional information at a more abstract level than the semantic information, for example the identification of a face as a specific person. Other semantic information and categorization can be used and the present invention includes such other semantic information and categorization. By matching the semantic information rather than processing the digital images each time a match is sought, a great deal of image processing and network communication is avoided, in addition to enabling a high degree of computing parallelism in the system as the different processors 72 of the different digital storage repositories 20 can do image processing on their own stored digital images 50 independently and at the same time.

According to an embodiment of the present invention, semantic or category information in a storage repository 20 is modified in response to matched information. For example, the processor 72 using the computer program 70 of the first digital storage repository 20 obtains semantic information from the second digital storage repository 20 and modifies the category semantic information of the first digital storage repository 20 in response to the obtained semantic information.

As shown in the embodiment of FIG. 10A, the categorization information can have a confidence metric value representing the likelihood that the information is correct. If a second storage repository has matching semantic or categorization information with a higher confidence value than that of a first storage repository, the matched semantic or categorization information is stored in the first storage repository. In this way, semantic information or categories are updated with new, improved, or corrected information. It is also possible to employ the confidence metric to select between conflicting semantic information about a similar digital image in two different digital storage repositories or to correct information found in one digital storage repository with information having a greater confidence found in a second digital storage repository.

Multiple computer programs and storage repositories can operate independently in a parallel processing fashion at the same time. Thus, the computer program 70 of the second person can obtain information from the digital storage repository 20 of the first person and modify the semantic or category information of the second digital storage repository 20 in response to the obtained information, at the same time as the computer program 70 of the first storage repository 20.

Given appropriate authorizations it is also possible for the program using the computer program 70 of the second digital storage repository 20 to modify the categories or semantic information in the first storage repository 20. That is, each computer program 70 can modify its own digital storage repository data and also the storage repository data of other digital storage repositories 20 for which it has authorization.

Given appropriate authorizations it is also possible for the computer program 70 of the first digital storage repository 20 to communicate information to the processor using the computer program 70 of the second digital storage repository 20 or the processor using the computer program 70 of the second digital storage repository 20 can communicate information to the processor using the computer program 70 of the first digital storage repository 20. In this way, one digital storage repository 20 is informed that changes in semantic information or categories for a digital image 50 have been made. If the digital image 50 is also stored in another digital storage repository 20, the processor using the computer program 70 associated with the other digital storage repository 20 can then perform an update.

The digital storage repositories 20 can maintain a list of digital images 50 that are known to be stored in other digital storage repositories 20 and the location of the digital storage repositories 20, for example digital storage repositories within a shared authorization group can maintain lists and locations of digital images stored on digital storage repositories within the authorization group. The digital image list can be updated as is semantic information when matches are found. For example, as shown in FIG. 10A, a list of matched digital images 50 and a quality of the match are stored in a digital storage repository 20. Semantic information and digital image lists can include dated information to assist in determining updates. As additional digital images are added to the digital storage repository, the digital images are analyzed and metadata and semantic information extracted from the digital images 50.

The processors 72 using the computer programs 70 of the various digital storage repositories 20 can operate independently. Periodically, the processors 72 can sample the semantic information of other digital storage repositories 20 to look for new semantic or category information. Hence, the processors 72 in the plurality of digital storage repositories 23 repeatedly over time independently access and match semantic information in one digital storage repository 20 with the semantic information in another digital storage repository 20 and independently associate a category associated with a digital image having the matched semantic information with a digital image having the matched semantic information that does not have the associated category. This has the result that information will, over time, diffuse within an authorization group. If authorization groups are inter-linked, the semantic information and categories will diffuse within the linked groups. For example, referring to FIGS. 10A-10D, if storage repository D has categorization information for digital image B (e.g. category Z), the processor associated with storage repository F in a common authorization group with storage repository D (authorization group B93) can access and match the semantic information in storage repository D for digital image B, and store the category in association with digital image B in storage repository F (as shown in FIG. 10B). After the category Z has been stored in storage repository F, the processor associated with storage repository C in common authorization group C12 with storage repository F can access and match the semantic information for digital image B and store the category in association with digital image B on storage repository C (FIG. 10C). Finally, since storage repositories A and C are in a common authorization group A47, the processor associated with storage device A can access and match the semantic information for digital image B in storage repository C and store the category in association with digital image B on storage repository A (FIG. 10D).

In various embodiments of the present invention, the remote communication network 34 is the interne. Storage devices, digital cameras, and digital images can have identifiers. The digital storage repositories 20 within an authorization group can include a common identifier that serves as an authorization code to authorize the digital storage repositories 20 within the authorization group to access the semantic information and categories in the digital storage repositories. The digital storage repositories 20 can be functionally identical, behaving in similar fashion and performing the same tasks and intercommunicating with different information and on different computers.

Computer programs that analyze digital images and extract metadata and semantic data from the digital images are known. Likewise, programs that match database entries or match information stored in a database or in association with digital images are known. According to another embodiment of the present invention, digital images 50 stored in a digital storage repository 20 also include image metadata, for example stored in the image header or in a database.

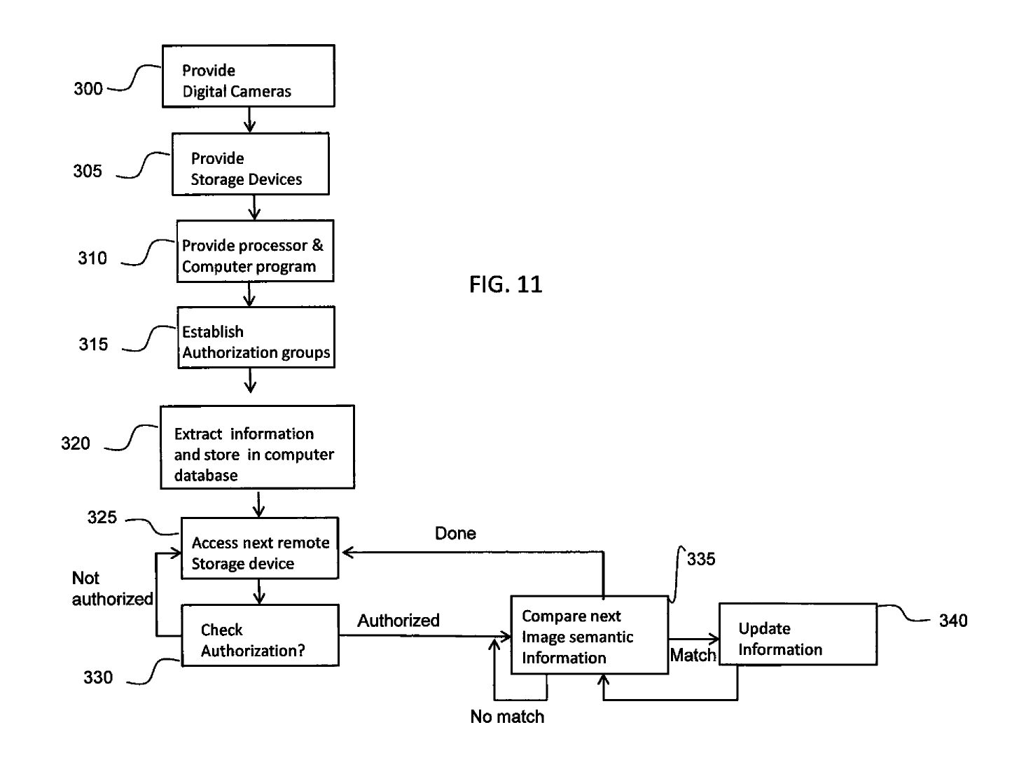

Referring to FIG. 11, in a method of the present invention, digital cameras, storage devices, and a processor and computer program are provided in steps 300, 305, and 310 respectively. Authorization groups are established in step 315, for example by persons interacting with their storage devices through a web browser managed by the storage devices or a third party web server. A third party web server can be managed by a vendor of the storage devices. Persons can also provide other persons with access codes permitting them to join existing authorization groups.

The processor 72 for each storage device 20 can independently undertake to analyze the images stored in the storage device 20 and to extract image metadata and semantic data, and to categorize the images in step 320. Alternatively, image information is received from other sources. Conventional computers can be employed and algorithms to do the image analysis, metadata extraction, and semantic data development are known.

Once the digital image metadata, semantic information and categories are established, the storage device processors can inter-communicate to access each other's digital image databases over a common network. Information about the location of storage devices 20 on a network can be found by using discovery protocols within a network, through a central registry of storage devices, or by explicitly entering location information into a storage device. Useful protocols, central servers, and user interfaces for providing information to a computing device are known in the art. A storage device processor can then access other known remote storage devices, in step 325. Note that of the storage device processors can operate independently and at the same time execute the steps described. Once accessed, the authorization information for a remote storage device 20 is checked in step 330. If authorization is not provided, the storage device 20 is not authorized to access the remote storage device information and the storage device processor can then check the next remote storage device 20 (by returning to step 325). If the remote storage device 20 is part of a common authorization group with the storage device 20, the storage device processor can access the semantic information and categories of the remote storage device. Semantic information for digital images held in common is compared (step 335). Alternatively, semantic information is compared to establish whether digital images are common, or at least very similar, and, if a match is found, semantic or category information is updated (step 340). Because it is not necessary to actually process images to determine a match, the matching process is relatively fast and requires little network bandwidth. Once the category or semantic information is updated for found matches, or if no match is found, the storage device processor can check the next digital image semantic information, updating when matches are found, until the digital image semantic information has been checked, at which point the matching for the remote storage device is done and the next storage device checked (returning to step 325).

When the storage devices 20 have been checked, the process can begin again, either immediately or after some pre-defined interval, or at the request of an person.

In addition to the semantic information and categories, each storage device 20 can maintain a list of known storage devices and their network address, for example an IP address. As well as updating semantic and category information, a storage device can maintain a list of known storage devices or known storage devices within an authorization group or within of the authorization groups of which the storage device is a member. In this way, over time each storage device will iteratively acquire more information stored in storage devices within the authorization group and the semantic and category information for shared or similar images will diffuse throughout the storage devices within the authorization group. Hence, each owner, operator, or user of a storage device benefits from semantic and category information provided or developed from any other storage device in an authorization group. Similarly, each owner, operator, or user of a storage device can provide to other storage devices within an authorization group his or her own semantic information, category information, or digital image list as other, remote storage devices access his or her storage device. This semantic and category information is useful to understand and use the digital images within a storage device.

A method of the present invention for storing digital images 50 and accessing and storing digital image information includes providing a system as described above. Once the system is operable, a plurality of digital storage repositories 23 can receive and store authorizations. The plurality of digital storage repositories 23 can include digital storage repositories 20 that are part of the same and different authorization groups. Semantic information associated with digital images 50 stored in storage devices 20 that are part of the same authorization group is matched and any category associated with a digital image 50 in one digital storage repository 20 having semantic information matched to the semantic information of the digital image 50 in another different digital storage repository 20 in the same authorization group is stored in the one digital storage repository 20.

In another embodiment of the present invention, a digital storage repository 20 for storing digital images 50 and accessing and storing digital image information for use with a network of digital storage repositories 20 using a communication network, the digital storage repository 20 includes a processor 72 and at least one computer program 70 associated with the processor 72 that stores and retrieves over the remote communication network 34 semantic information derived from the digital images 50 and categories associated with the semantic information. The digital storage repository 20 is associated with one or more different authorization groups, each authorization group enabling access by the digital storage repository 20 to other digital storage repositories within the authorization group. Each processor 72 uses its computer program 70 to store and retrieve over the local or remote communication network 32, 34 semantic information derived from the digital images 50 and categories associated with the derived semantic information, to match semantic information from other digital storage repositories in a common authorization group, and to associate a category with matched semantic information. The digital storage repository 20 includes a first digital image 50 with associated first semantic information and wherein another digital storage repository 20 in a common authorization group with the digital storage repository 20 includes a second digital image 50 with associated second semantic information and an associated second category. The processor 72 of the first digital storage repository 20 uses its computer program 70 to independently access and match the first semantic information with the second semantic information, to associate the second category with the first semantic information, and to store the second category in association with the first semantic information in the digital storage repository 20.

In another embodiment of the present invention, a method for storing digital images 50 and accessing and storing digital image information includes receiving a system such as that described above, receiving and storing authorizations in a plurality of digital storage repositories, the plurality of digital storage repositories 23 including digital storage repositories 20 that are part of the same and different authorization groups, matching semantic information associated with digital images 50 stored in storage devices 20 that are part of the same authorization group, associating the category of a digital image 50 in one digital storage repository 20 with a digital image 50 having semantic information matched to the semantic information of the digital image 50 in another different digital storage repository 20 in the same authorization group, and storing the associated category in the one digital storage repository 20.

In various embodiments of the present invention, the remote communication network 34 is the internet, the local communication channel is a wireless local area network, or the local communication channel is a dock interface between a storage device 20 and a digital camera 10. The system can include a plurality of functionally identical storage devices, each having a unique communication network address identifier, for example an internet protocol address or universal resource locater or universal resource indicator. Each storage device can be associated with one or more digital cameras. Multiple storage devices can be associated with a single digital camera, for example to expand the available storage space or to provide backup for stored information.

Storage devices are known in the art, as are wireless circuits and communication methods. Digital computing circuits and computers are known and software to manage the transfer and organization of digital images on one or multiple devices are known. Digital cameras are also commercially available. These tools are used to implement the digital image system of the present invention.

In one embodiment, the storage devices are configured to each provide a separate and distinct single logical storage structure. Alternatively, groups of storage devices together can provide a separate and distinct single logical storage structure. According to various embodiments of the present invention, a single logical storage structure is separately provided for each identified user of the digital image system, for example for multiple users of a single digital camera. Alternatively, a single logical storage structure is organized for individual cameras. In yet another alternative, a single logical storage structure is shared between multiple users or multiple cameras.

The invention has been described in detail with particular reference to certain preferred embodiments thereof, but it will be understood that variations and modifications can be effected within the spirit and scope of the invention.

### PARTS LIST

A, B, C, D, E, F storage devices or repositories
A47, B93, C12 authorization groups
10, 10A, 1013 digital camera
11 second digital camera
12 user interface
12a speaker
12b microphone
12c touch screen
13 camera identifier
14 image sensor
16 digital camera controller
18 camera communication circuit
20 storage device or repository
21 second storage device or repository
22 storage identifier
23 plurality of storage devices or repositories
24 storage memory
26 storage controller
28 storage communication circuit
30 local communication channel
30A, 30B, 30C local wireless communication channel
32 local communication network
34 remote communication network
40 computer
50 information, digital images
70 computer program
72 processor
74 authorization group
95 provide camera and storage device step
100 communication path
101 read identifier on storage device step
102 enter identifier with user interface step
103 send identifier to storage device step
110 communication path
111 camera receives identifier step
112 match identifier to storage device step
113 accept identifier with user interface step
120 communication path
121 enter identifier with user interface step
122 camera receive encrypted communication step
123 camera decrypt communication with identifier step
130 communication path
131 photograph identifier on storage device step
132 extract identifier from photo step
133 accept identifier with user interface step
140 store identifier in camera step
200 set camera id# step
205 user recorded/selected image step
210 modified image step
215 storage device status step
220 store image in user account step
225 instruct user to setup step
230 instruct user to move camera step
235 switch to “limited range” step
240 add storage # id to modified user image step
245 create user account step
250 present user account icon step
300 provide digital cameras step
305 provide storage devices step
310 provide computer and computer program step
315 establish authorization groups step
320 extract and store information step
325 access remote storage device step
330 check authorization step
335 compare semantic information step
340 update information step

1. A system for storing digital images and accessing and storing digital image information using a communication network, comprising:
a plurality of independently controlled digital storage repositories for storing digital images, each digital storage repository having a processor and an associated computer program, connected to the communication network, and wherein each digital storage repository is associated with one or more different authorization groups, each authorization group enabling access by the digital storage repositories within the authorization group to the digital storage repositories within the authorization group;
wherein each processor of each digital image repository uses its computer program to store and retrieve over the communication network semantic information derived from the digital images and categories associated with the derived semantic information, to match semantic information from other digital storage repositories in a common authorization group, and to associate a category with matched semantic information;
wherein a first digital storage repository includes a first digital image with associated first semantic information and wherein a second digital storage repository in a common authorization group with the first digital storage repository includes a second digital image with associated second semantic information and an associated second category, and
wherein the processor of the first digital storage repository uses its computer program to independently access and match the first semantic information with the second semantic information, to associate the second category with the first semantic information, and to store the second category in association with the first semantic information in the first digital storage repository.

2. The system of claim I, wherein the processor of the first digital storage repository uses its computer program to obtain semantic information from the second digital storage repository and modify the category or the semantic information of the first digital storage repository in response to the obtained semantic information.

3. The system of claim 1, wherein the processor of the second digital storage repository uses its computer program to obtain semantic information from the first digital storage repository and store or modify the semantic or category information of the first digital storage repository in response to matched semantic information.

4. The system of claim 1, wherein the processor of the first digital storage repository uses its computer program to communicate information to the processor of the second digital storage repository or the processor of the second digital storage repository uses its computer program to communicate information to the processor of the first digital storage repository.

5. The system of claim 1, wherein at least some of the semantic information in the digital repositories includes a confidence value representing a correctness estimate of the semantic information.

6. The system of claim 5, wherein the confidence metric is used by the processor to select between or correct conflicting semantic information or categories for a common or similar digital image in two different digital storage repositories.

7. The system of claim 1, wherein a digital storage repository includes a list of digital images that are stored in other different storage repositories and includes digital image storage location information for the digital images in the list.

8. The system of claim 1, wherein semantic information is stored in a database.

9. The system of claim 8, wherein the processor of a digital storage repository uses its computer program to communicate semantic information changes to the processor associated with a different digital storage repository.

10. The system of claim 1, wherein one or more digital storage repositories are members of two or more different authorization groups.

11. The system of claim 1, wherein a digital image is included in two or more different storage repositories.

12. The system of claim 1, wherein the two or more different storage repositories are in different authorization groups.

13. The system of claim 1, wherein the plurality of processors repeatedly over time each use their computer program independently to access and match semantic information in one digital storage repository with the semantic information in another digital storage repository and independently to associate a category associated with a digital image having the matched semantic information with a digital image having the matched semantic information that does not have the associated category.

14. The system of claim 1, wherein the communication network is the Internet.

15. The system of claim 1, wherein each digital storage repository includes at least one identifier, each authorization group includes at least one identifier, or each digital image includes at least one identifier.

16. The system of claim 1, wherein the digital storage repositories within an authorization group include a common identifier that serves as an authorization code to authorize the digital storage repositories within the authorization group to access the semantic information and categories in the digital storage repositories.

17. The system of claim 1, wherein the processor use the one or more computer programs to analyze the digital images and to extract and associate semantic information from the digital images with the digital images.

18. The system of claim 1, wherein the digital storage repositories are functionally identical.

19. A method for storing digital images and accessing and storing digital image information comprising providing a system according to claim 1.

20. The method of claim 19, further including providing:
receiving and storing authorizations in a plurality of digital storage repositories, the plurality of digital storage repositories including digital storage repositories that are part of the same and different authorization groups;
matching semantic information associated with digital images stored in storage devices that are part of the same authorization group;
associating the category of a digital image in one digital storage repository with a digital image having semantic information matched to the semantic information of the digital image in another different digital storage repository in the same authorization group, and
storing the associated category in the one digital storage repository.

21. A digital storage repository for storing digital images and accessing and storing digital image information for use with a network of other digital storage repositories that have digital images with associated semantic information and associated categories using a communication network, the digital storage repository comprising;
a processor and at least one computer program associated with the processor that stores and retrieves over the communication network semantic information derived from the digital images and categories associated with the semantic information;
wherein the digital storage repository is associated with one or more different authorization groups, each authorization group enabling access by the digital storage repository to other digital storage repositories within the authorization group;
wherein the processor uses its computer program to store and retrieve over the communication network semantic information derived from the digital images and categories associated with the derived semantic information, to match semantic information from other digital storage repositories in a common authorization group, and to associate a category with matched semantic information;
wherein the digital storage repository includes a first digital image with associated first semantic information and is in communicable association with at least one other digital storage repository in a common authorization group, and
wherein the processor of the first digital storage repository uses its computer program to independently access and match the first semantic information with the semantic information of a digital image in the other digital storage repository, to associate a category of the other digital image with the first semantic information, and to store the category in association with the first semantic information in the digital storage repository.

22. A method for storing digital images and accessing and storing digital image information comprising:
receiving a system according to claim 1;
receiving and storing authorizations in a plurality of digital storage repositories, the plurality of digital storage repositories including digital storage repositories that are part of the same and different authorization groups;
matching semantic information associated with digital images stored in storage devices that are part of the same authorization group;
associating the category of a digital image in one digital storage repository with a digital image having semantic information matched to the semantic information of the digital image in another different digital storage repository in the same authorization group, and
storing the associated category in the one digital storage repository.
